(19) United States
(12) Patent Application Publication
(10) Pub. No.: US 2006/0202548 A1
(43) Pub. Date: Sep. 14, 2006

(54) Wheel structure

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/076,981

(22) Filed: Mar. 11, 2005

(51) Int. Cl. B60B 1/00

(52) U.S. Cl. 301/5.1

(57) ABSTRACT

A wheel structure includes a main wheel body, a pair of extension sections extending from respective sides of the main wheel body, and a pair of auxiliary sections coaxially extending from the extension sections, respectively. The main wheel body of the wheel has a larger outer diameter than the outer diameters of the auxiliary sections. Both the main wheel body and the auxiliary sections are provided with outer tires made in a different material. The wheel increases contact surfaces with the ground when making turns, so as to prevent overturning.

### BACKGROUND OF THE INVENTION

1. Field of the Invention

This invention relates to a wheel structure applied to playing or sporting vehicles such as scooters, tricycles, bicycles, skateboards, roller skates, training cycles, hand-pulling suitcases, hand carts, shopping carts, toy carts or balancing wheels, and more particularly to a wheel having two auxiliary sections at respective sides of a main wheel body to increase contact surfaces of the wheel with the ground.

2. Description of the Prior Art

Most scooters, tricycles or bicycles for children are mounted with wheels (B) to a cart (A), as shown in FIG. 8, to facilitate movement of the cart (A). When the cart (A) makes a turn, it is difficult to control turning movement because the wheels (B) are small in size. Sometimes the cart (A) may even turnover if the turn is made too wide.

In order to correct the shortcoming, an egg-shaped wheel (C) was derived, as shown in FIG. 9, to provide the stability when making turns. The egg-shaped wheel (C) has its center surface (C1) in touch with the ground constantly. When the cart (A) is turning, due to the centrifugal force, the cart (A) leans towards one side, and so does the egg-shaped wheel (C). The egg-shaped wheel (C) will lean with its arc surface (C2) to get in touch with the ground, as shown in FIG. 10, which provides a stable position to the cart (A). However, if the turning angle is too big, the cart (A) still may encounter the possibility of overturning.

In order to overcome the above-mentioned shortcoming, a wheel (D) mounted with auxiliary wheels (D1) is derived later, as shown in FIG. 11, to support the wheel (D) of the cart in turning. However, the auxiliary wheels (D1) increase the cost of manufacture and assembly, and it easily malfunctions.

### SUMMARY OF THE INVENTION

It is the primary objective of the present invention to provide a wheel structure, which provides with more contact surfaces for a cart to get in touch with the ground and more stable to riders.

It is another objective of the present invention to provide a wheel structure, which uses less parts to save time in assembly and has less noise.

It is a further objective of the present invention to provide a wheel structure, which comprises a main wheel body and auxiliary sections formed integrally by blowing molding or injection molding. The wheel is provided with an outer tire formed in an injection or casting method or mounted to the wheel, thus it is cost effectiveness

### BRIEF DESCRIPTION OF THE DRAWINGS

FIG. 1 is a perspective view of a first embodiment of the present invention;

FIG. 2 is a front view of the first embodiment of the present invention in a riding status;

FIG. 3 is a front view of the first embodiment of the present invention in a turning status;

FIG. 4 is a front view of a second embodiment of the present invention;

FIG. 5 is a front view of a third embodiment of the present invention;

FIG. 6 is a front view of a fourth embodiment of the present invention;

FIG. 7 is a cross-sectional view of a fifth embodiment of the present invention;

FIG. 8 is a side view of a conventional wheel;

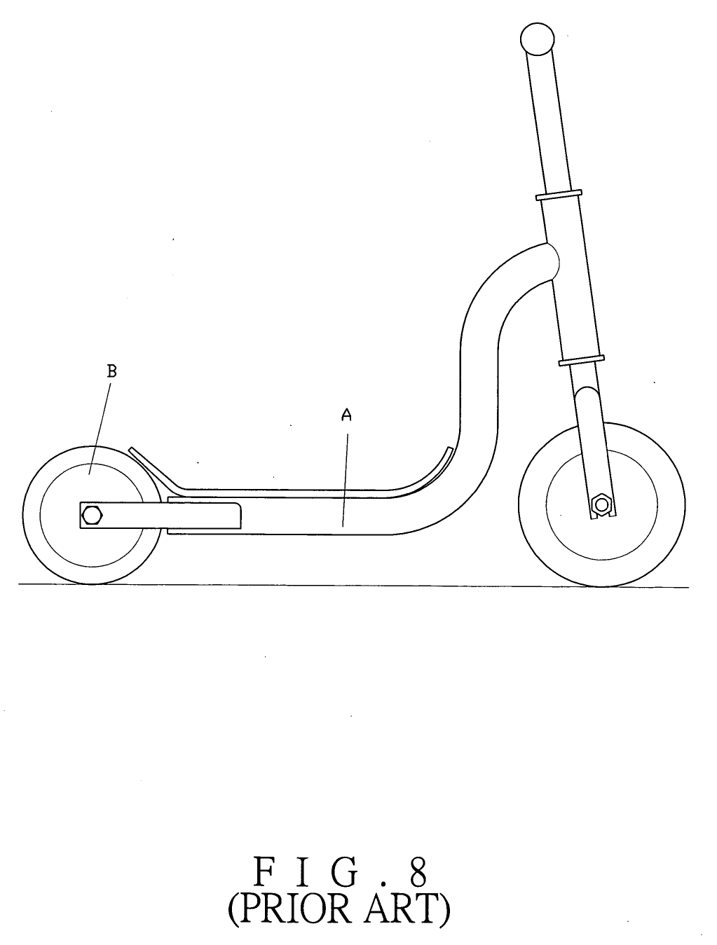

FIG. 9 is a front view of another conventional wheel;

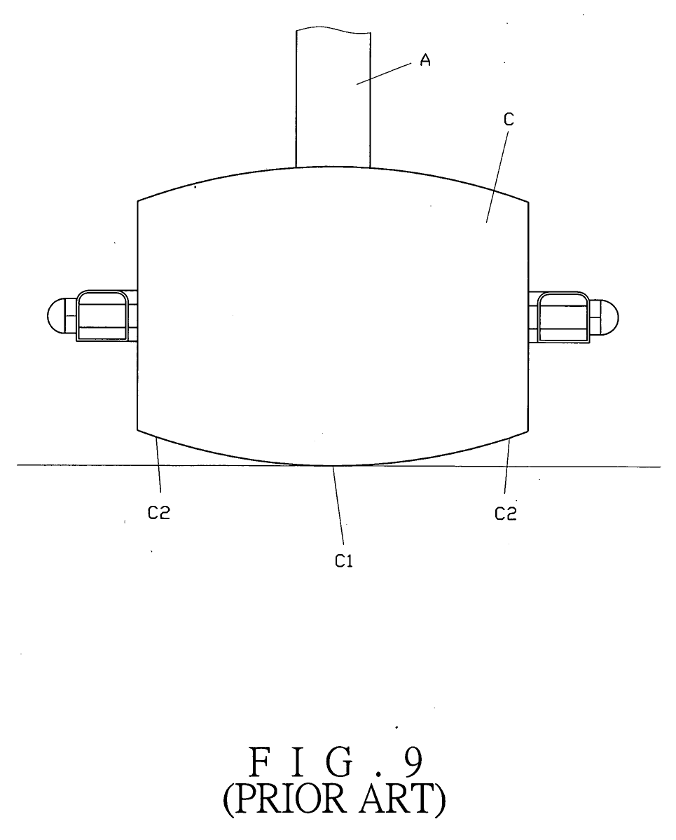

FIG. 10 is a front view of FIG. 9 in a turning status; and

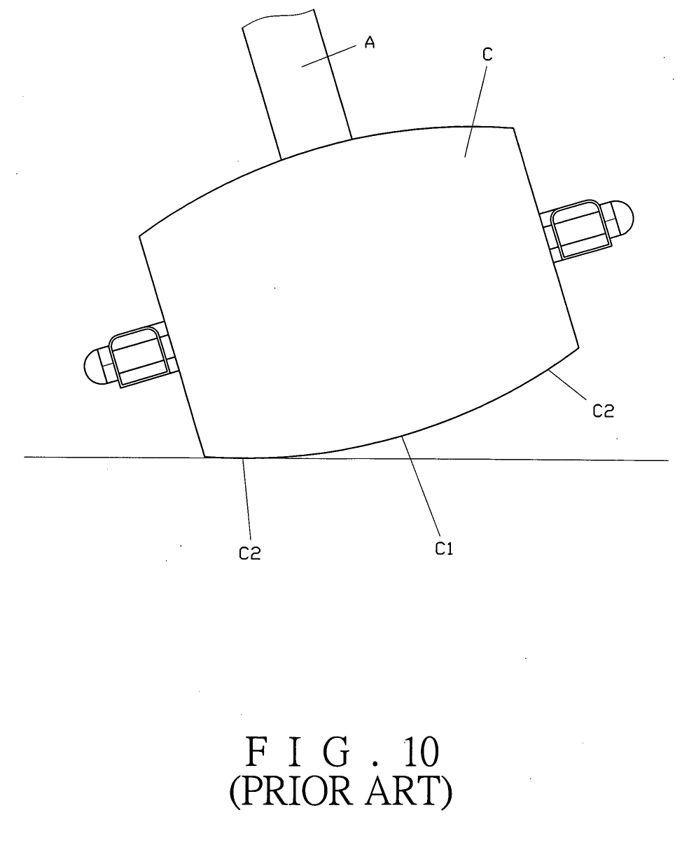

FIG. 11 is view of a conventional wheel with auxiliary wheels.

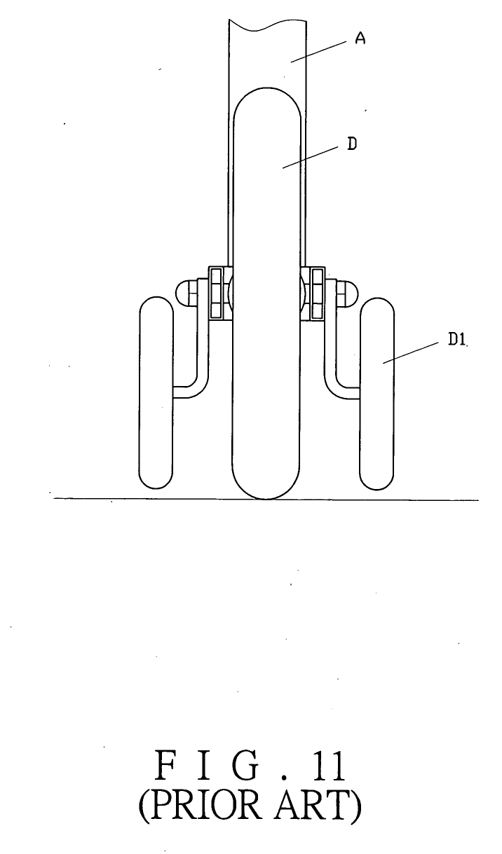

### DETAILED DESCRIPTION OF THE PREFERRED EMBODIMENTS

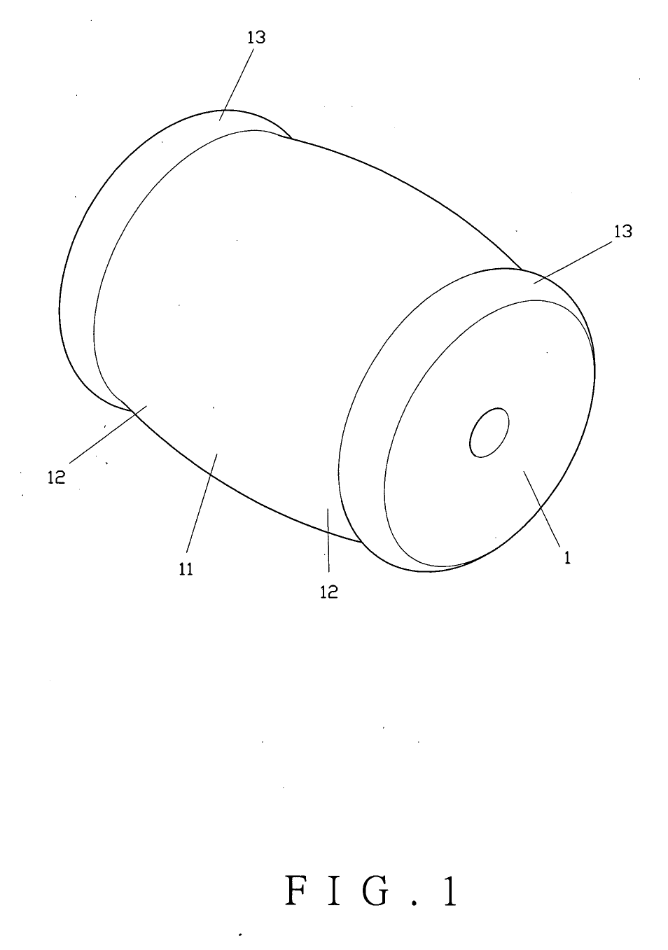

As shown in FIG. 1, a first embodiment of the present invention comprises a wheel (1) having a main wheel body (11) at the center portion for direct contact with the ground. The main wheel body (11) has its two sides extending to form a pair of extension sections (12) to get in touch with the ground when making turns. Each extension section (12) extends outwardly to form an auxiliary section (13). The main wheel body (11) of the wheel (1) has a larger outer diameter than the outer diameters of the auxiliary sections (13) to increase the contact surfaces with the ground when making turns. The auxiliary sections (13) are integral to the main wheel body (11).

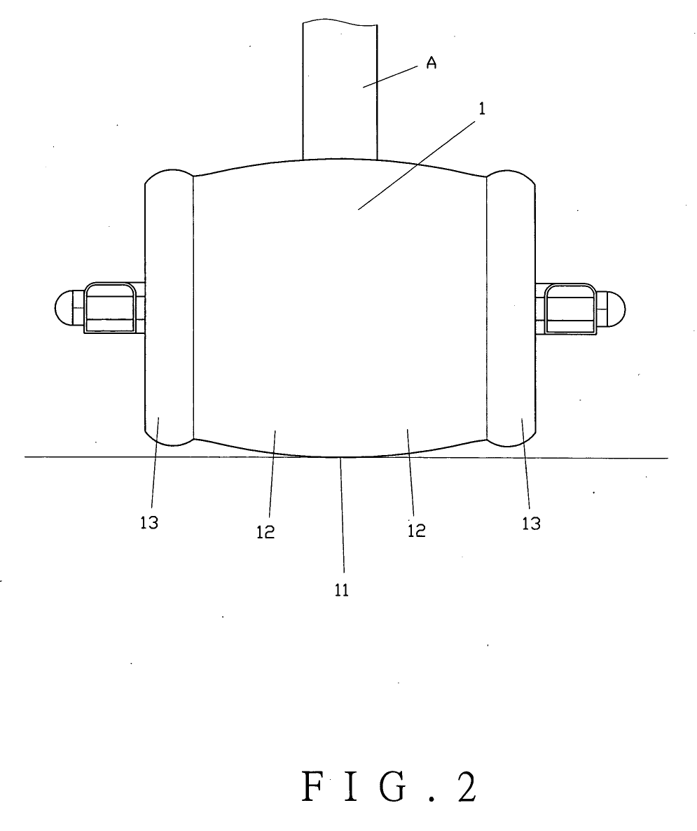

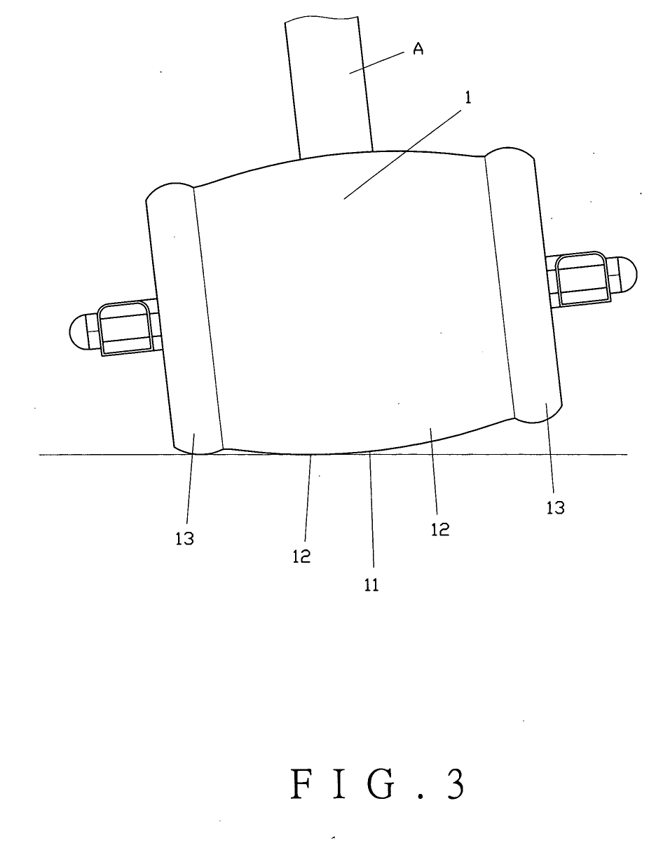

To operate the present invention, as shown in FIGS. 2 and 3, the wheel (1) is pivotally connected to a cart (A). When the cart (A) is rolling in a straight direction, the main wheel body (11) of the wheel (1) remains contact with the ground. When the cart (A) makes a turn, due to the centrifugal force, the wheel (1) will incline with the cart (A), which makes either extension section (12) touch the ground at this moment. The auxiliary section (13) is also in touch with the ground to increase contact surface between the wheel (1) and the ground to provide a steady riding status when the turning angle is too big.

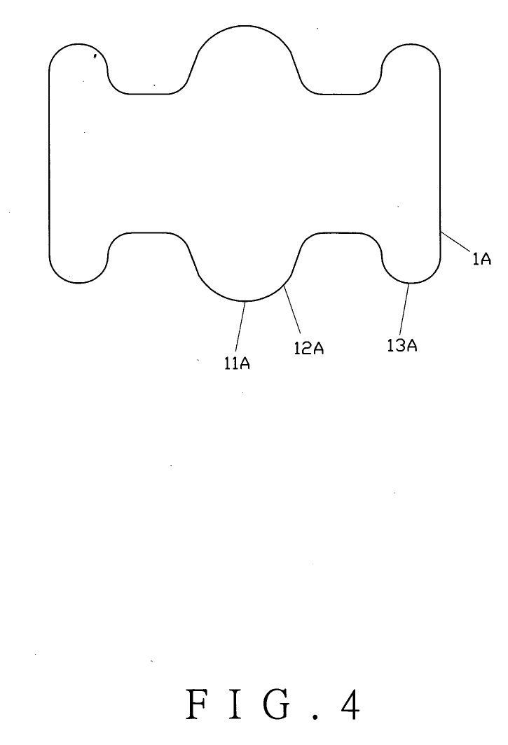

A second embodiment of the present invention comprises a wheel (1A) as shown in FIG. 4. The wheel (1A) has a main wheel body (11A) at the center portion, a pair of extension sections (12A) extending from respective sides of the main wheel body (11A), and a pair of auxiliary sections (13A) coaxially extending from the extension sections (12A), respectively. The main wheel body (11A) of the wheel (1A) has a larger outer diameter than the outer diameters of the auxiliary sections (13A). The extension sections (12A) are spaced from the auxiliary sections (13A).

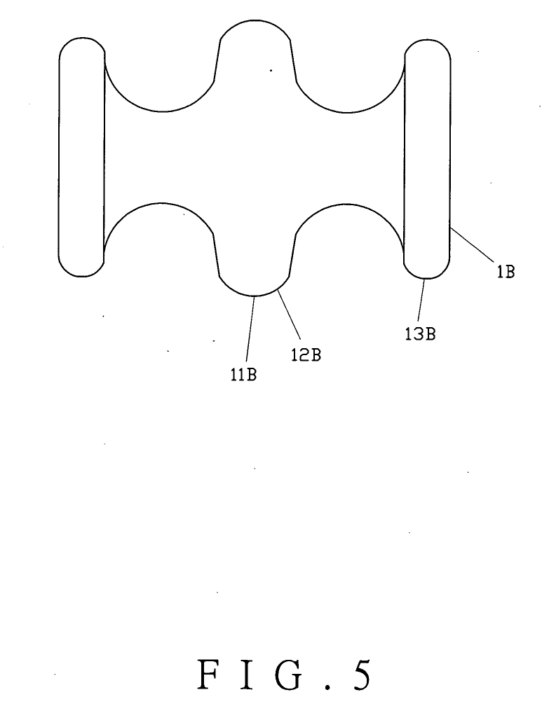

A third embodiment of the present invention comprises a wheel (1B), as shown in FIG. 5. The wheel (1B) comprises a main wheel body (11B) at the center portion to be in touch with the ground when the cart is rolling. The main wheel body (11B) has its two sides extending outwardly to form a pair of extension sections (12B) and a pair of auxiliary sections (13B) coaxially extending from the extension sections (12B), respectively. The main wheel body (11B) of the wheel (1B) has a larger outer diameter than the outer diameters of the auxiliary sections (13B). The extension sections (12B) are spaced from the auxiliary sections (13B).

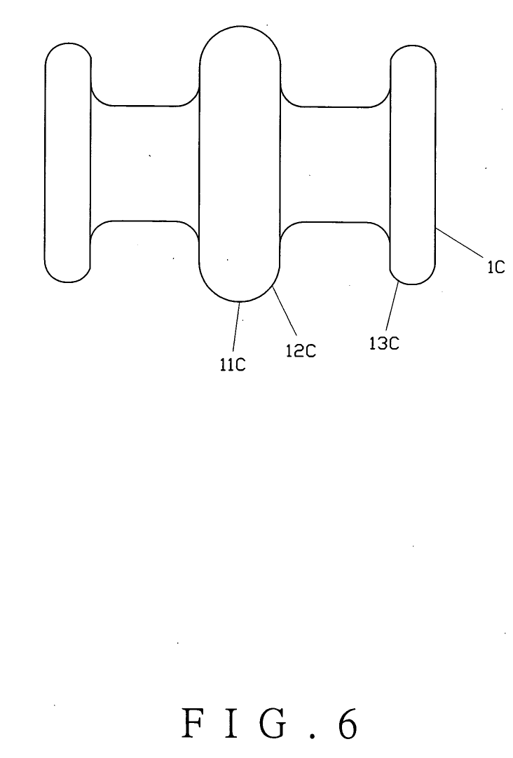

A fourth embodiment of the present invention comprises a wheel (1C), as shown in FIG. 6. The wheel (1C) comprises a main wheel body (11C) at the center portion to get in touch with the ground when the cart is rolling. The main wheel body (11C) has its two sides extending outwardly to form a pair of extension sections (12C) and a pair of auxiliary sections (13C) coaxially extending from the extension sections (12C), respectively. The main wheel body (11C) of the wheel (1C) has a larger outer diameter than the outer diameters of the auxiliary sections (13C). The extension sections (12C) are spaced from the auxiliary sections (13C).

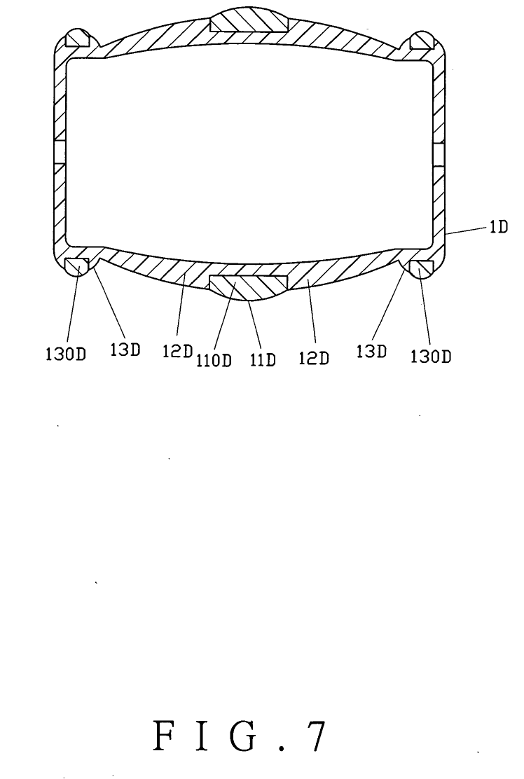

A fifth embodiment of the present invention comprises a wheel (1D), as shown in FIG. 7. The wheel (1D) comprises a main wheel body (11D) at the center portion to get in touch with the ground when the cart is rolling. The main wheel body (11D) has its two sides extending outwardly to form a pair of extension sections (12D) and a pair of auxiliary sections (13D) coaxially extending from the extension sections (12D), respectively. The main wheel body (11D) of the wheel (1D) has a larger outer diameter than the outer diameters of the auxiliary sections (13D). The extension sections (12D) are spaced from the auxiliary sections (13D).

Furthermore, the main wheel body (11D) is provided with an outer tire (110D) made in a different material. The auxiliary sections (13D) are also provided with outer tires (130D) made in a different material. Both the outer tires (110D) and (130D) may be formed in an injection or casting method or mounted directly to the wheel. Both the outer tires (110D) and (130D) have larger outer diameters than the outer diameters of the main wheel body (11D) and the auxiliary sections (13D).

What is claimed is:

1. A wheel structure comprising a main wheel body and auxiliary sections wherein said auxiliary sections are integral with said main wheel body, said main wheel body having an outer diameter larger than outer diameters of said auxiliary sections.

2. The wheel structure, as recited in claim 1, wherein the wheel is formed with said main wheel body at a center portion, a pair of extension sections extending from respective sides of said main wheel body, and said auxiliary sections coaxially extending from said extension sections, respectively.

3. The wheel structure, as recited in claim 1, wherein said main wheel body and said auxiliary sections are provided with outer tires made in a different material.

4. The wheel structure, as recited in claim 3, wherein said outer tires are formed in an injection method.

5. The wheel structure, as recited in claim 3, wherein said outer tires are formed in a casting method.

6. The wheel structure, as recited in claim 3, wherein said outer tires are mounted directly to the wheel.
